(19) United States
(12) Patent Application Publication
(10) Pub. No.: US 2010/0049512 A1
(43) Pub. Date: Feb. 25, 2010

(54) ENCODING DEVICE AND ENCODING METHOD

(75) Inventors: Masahiro Oshikiri, Kanagawa (JP); Tomofumi Yamanashi, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/518,375

(22) PCT Filed: Dec. 14, 2007
(86) PCT No.: PCT/JP2007/074134

§ 371 Date: Jun. 9, 2009

(30) Foreign Application Priority Data
Dec. 15, 2006 (JP) 2006-339242

(51) Int. Cl. G10L 21/06

(52) U.S. Cl. 704/230; 704/E21.019

(57) ABSTRACT

Disclosed is an encoding device and others capable of suppressing quantization distortion while suppressing increase of a bit rate when encoding audio or the like. In the device, a dynamic range calculation unit (12) calculates a dynamic range of an input spectrum as an index indicating a peak of the input spectrum, a pulse quantity decision unit (13) decides the number of pulses of a vector candidate outputted from a shape codebook (14), and a shape codebook (14) outputs a vector candidate having the number of pulses decided by the pulse quantity decision unit (13) according to control from the search unit (17) by using a vector candidate element {−1, 0, +1}.

### TECHNICAL FIELD

The present invention relates to an encoding apparatus and encoding method used for encoding speech signals and such.

### BACKGROUND ART

In a mobile communication system, speech signals are required to be compressed at a low bit rate for efficient use of radio wave resources.

As coding for speech signal compression at low bit rate, studies are underway to use transform coding such as AAC (Advanced Audio Coding) and TwinVQ (Transform Domain Weighted Interleave Vector Quantization). In transform coding, by forming one vector with a plurality of error signals and quantizing this vector (i.e. vector quantization), it is possible to perform efficient coding.

Further, in vector quantization, generally, a codebook accommodating many vector candidates is used. The encoding side searches for an optimal vector candidate by performing matching between an input vector targeted for quantization and the plurality of vector candidates accommodated in the codebook, and transmits information (i.e. index) to indicate the optimal vector candidate to the decoding side. The decoding side uses the same codebook as on the encoding side and selects an optimal vector candidate with reference to the codebook based on the received index.

In such transform coding, vector candidates accommodated in a codebook influence the performance of vector quantization, and, consequently, it is important how to design the codebook.

As a general method of designing a codebook, there is a method of using an enormous number of input vectors as training signals and learning to minimize distortion with respect to the training signals. If a codebook for vector quantization is designed by learning using training signals, learning is performed based on a model to minimize distortion, so that it is possible to design a codebook of high performance.

However, when a codebook is designed by learning using training signals, all vector candidates need to be recorded, and, consequently, there is a problem that the codebook requires an enormous memory capacity. When the number of dimensions (i.e. elements) of vectors is M and the number of bits for a codebook is B bits (i.e. the number of vector candidates is 2^{B}), the codebook requires a memory capacity of M×2^{B} words. Normally, to acquire good performance in vector quantization, approximately 0.5 to 1 bit per element is required, and, consequently, the codebook requires at least 16 bits in the case of M=32. In this case, the codebook requires an enormous memory capacity of approximately 2M words.

To reduce the memory capacity of a codebook, there are methods of using a multi-stage codebook, representing a vector in a divided manner and so on. However, even if these methods are adopted, the memory capacity of a codebook is only one several-th, that is, the effect of reducing the memory capacity is insignificant.

Here, instead of designing a codebook by learning, there is a method of representing vector candidates by using initial vectors prepared in advance and rearranging the elements included in these initial vectors and changing the polarities (i.e. positive and negative signs) (see Non-Patent Document 1). With this method, many kinds of vector candidates can be represented from few kinds of predetermined initial vectors, so that it is possible to significantly reduce the memory capacity a codebook requires.

Non-Patent Document 1: M. Xie and J.-P. Adoul, “Embedded algebraic vector quantizer (EAVQ) with application to wideband speech coding”, Proc. of the IEEE ICASSP'96, pp. 240-243, 1996

### DISCLOSURE OF INVENTION

### Problem to be Solved by the Invention

However, to realize high quality coding of input speech signals having various characteristics (such as pulsive speech signals and noisy speech signals) using the above-noted method, it is necessary to increase the number of kinds of predetermined initial vectors to generate vector candidates matching the characteristics of input speech signals. Therefore, the number of codes becomes enormous to represent vector candidates, which causes an increase in the bit rate.

On the other hand, if the kinds of predetermined initial vectors are limited to suppress an increase in the bit rate, it is not possible to generate vector candidates for pulsive speech signals and noisy speech signals, which results in increased quantization distortion.

It is therefore an object of the present invention to provide an encoding apparatus and encoding method that can suppress an increase in the bit rate and sufficiently suppress quantization distortion.

### Means for Solving the Problem

The encoding apparatus of the present invention employs a configuration having: a shape codebook that outputs a vector candidate in a frequency domain; a control section that controls a distribution of pulses in the vector candidate according to sharpness of peaks in a spectrum of an input signal; and an encoding section that encodes the spectrum using the vector candidate after distribution control.

### ADVANTAGEOUS EFFECT OF THE INVENTION

According to the present invention, it is possible to suppress an increase in the bit rate and sufficiently suppress quantization distortion.

### BRIEF DESCRIPTION OF DRAWINGS

FIG. 1 is a block diagram showing the configuration of a speech encoding apparatus according to Embodiment 1 of the present invention;

FIG. 2 illustrates a method of calculating a dynamic range according to Embodiment 1 of the present invention;

FIG. 3 is a block diagram showing the configuration of a dynamic range calculating section according to Embodiment 1 of the present invention;

FIG. 4 illustrates configurations of vector candidates according to Embodiment 1 of the present invention;

FIG. 5 is a block diagram showing the configuration of a speech decoding apparatus according to Embodiment 1 of the present invention;

FIG. 6 is a block diagram showing the configuration of a speech encoding apparatus according to Embodiment 2 of the present invention;

FIG. 7 illustrates allocation positions of pulses in a vector candidate according to Embodiment 2 of the present invention;

FIG. 8 is a block diagram showing the configuration of a speech decoding apparatus according to Embodiment 2 of the present invention;

FIG. 9 is a block diagram showing the configuration of a speech encoding apparatus according to Embodiment 3 of the present invention;

FIG. 10A illustrates the shape of a dispersion vector (having the maximum value in the location of j=0) according to Embodiment 3 of the present invention;

FIG. 10B illustrates the shape of a dispersion vector (having the maximum value in the location of j=J/2) according to Embodiment 3 of the present invention;

FIG. 10C illustrates the shape of a dispersion vector (having the maximum value in the location of j=J−1) according to Embodiment 3 of the present invention;

FIG. 11 illustrates a state where dispersion is performed according to Embodiment 3 of the present invention;

FIG. 12 is a block diagram showing the configuration of a speech decoding apparatus according to Embodiment 3 of the present invention;

FIG. 13 is a block diagram showing the configuration of a speech encoding apparatus according to Embodiment 4 of the present invention;

FIG. 14 is a block diagram showing the configuration of a second layer encoding section according to Embodiment 4 of the present invention;

FIG. 15 illustrates a state of spectrum generation in a filtering section according to Embodiment 4 of the present invention;

FIG. 16 is a block diagram showing the configuration of a third layer encoding section according to Embodiment 4 of the present invention;

FIG. 17 is a block diagram showing the configuration of a speech decoding apparatus according to Embodiment 4 of the present invention;

FIG. 18 is a block diagram showing the configuration of a second layer decoding section according to Embodiment 4 of the present invention;

FIG. 19 is a block diagram showing the configuration of a third layer decoding section according to Embodiment 4 of the present invention;

FIG. 20 is a block diagram showing the configuration of a third layer encoding section according to Embodiment 5 of the present invention;

FIG. 21 is a block diagram showing the configuration of a third layer decoding section according to Embodiment 5 of the present invention;

FIG. 22 is a block diagram showing the configuration of a speech encoding apparatus according to Embodiment 6 of the present invention; and

FIG. 23 is a block diagram showing the configuration of a speech decoding apparatus according to Embodiment 6 of the present invention.

### BEST MODE FOR CARRYING OUT THE INVENTION

Embodiments of the present invention will be explained below in detail with reference to the accompanying drawings. An example case will be explained below where shape gain vector quantization is used to divide a spectrum into shape information and gain information, these information are quantized, and the present invention is applied to vector quantization of the shape information. Further, in the following embodiments, a speech encoding apparatus and a speech decoding apparatus will be explained as an example of an encoding apparatus and decoding apparatus.

### Embodiment 1

In a case where an input speech signal has high periodicity like vowels, the spectrum of the input speech signal has high sharpness of peaks and occurs only in the vicinity of integral multiples of the pitch frequency. In the case of such spectral characteristics, it is possible to acquire good coding performance using vector candidates in which pulses are allocated only in the peak parts. By contrast, in the case of such spectral characteristics, if many pulses are allocated in vector candidates, there are pulses also in unneeded elements, which adversely degrade coding performance.

On the other hand, in an input speech signal having high random characteristics like unvoiced consonants, the spectrum of the input speech signal also shows random characteristics. Consequently, in this case, it is preferable to perform vector quantization using vector candidates comprised of many pulses.

Therefore, according to the present embodiment, in a speech encoding apparatus that vector-quantizes an input speech signal in the frequency domain, the elements of vector candidates each are one of {−1, 0 and +1}, and the number of pulses in the vector candidates is changed according to sharpness of the peaks in the spectrum, thereby controlling the distribution of pulses in the vector candidates.

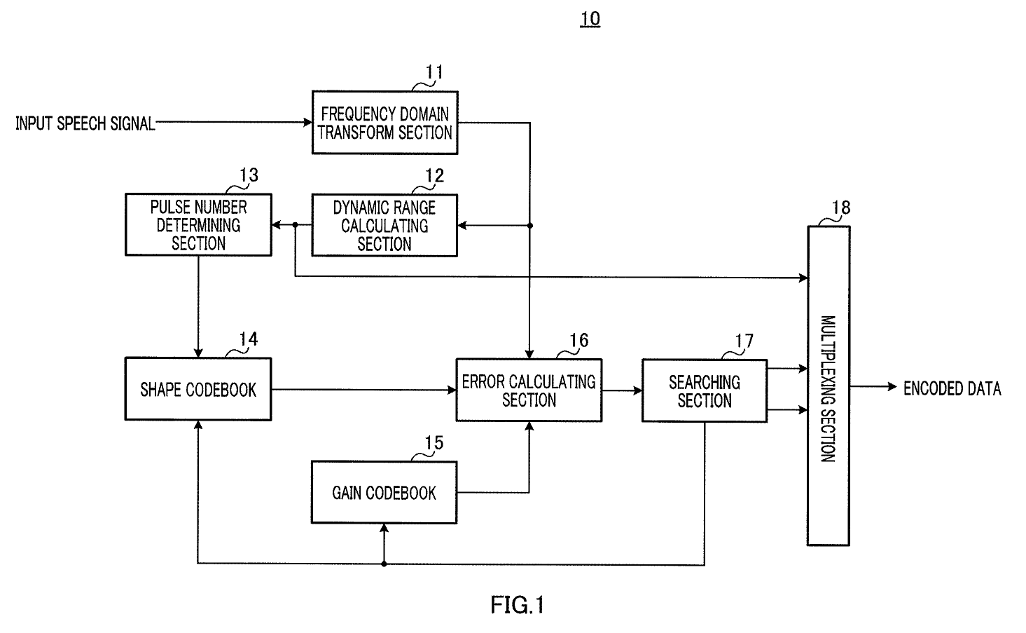

FIG. 1 is a block diagram showing the configuration of speech encoding apparatus 10 according to the present embodiment.

In speech encoding apparatus 10 shown in FIG. 1, frequency domain transform section 11 performs a frequency analysis of an input speech signal and finds the spectrum of the input speech signal (i.e. input spectrum) in the form of transform coefficients. To be more specific, frequency domain transform section 11 transforms a time domain speech signal into a frequency domain spectrum, using, for example, the MDCT (Modified Discrete Cosine Transform). The input spectrum is outputted to dynamic range calculating section 12 and error calculating section 16.

Dynamic range calculating section 12 calculates the dynamic range of the input spectrum as an indicator to show sharpness of peaks in the input spectrum, and outputs dynamic range information to pulse number determining section 13 and multiplexing section 18. Dynamic range calculating section 12 will be described later in detail.

Pulse number determining section 13 controls the distribution of pulses in vector candidates by changing the number of pulses in vector candidates to be outputted from shape codebook 14, according to the sharpness of peaks in the input spectrum. To be more specific, pulse number determining section 13 determines the number of pulses in vector candidates to be outputted from shape codebook 14, based on the dynamic range information, and outputs the determined pulses to shape codebook 14. In this case, pulse number determining section 13 reduces the number of pulses when the dynamic range of the input spectrum is higher.

Shape codebook 14 outputs frequency domain vector candidates to error calculating section 16. In this case, shape codebook 14 outputs vector candidates having the same number of pulses as determined in pulse number determining section 13, using vector candidate elements {−1, 0 and +1}. Further, according to control from searching section 17, shape codebook 14 repeat selecting a vector candidate from a plurality kinds of vector candidates having the same number of pulses in different combinations, and outputting a result to error calculating section 16 in order. Shape codebook 14 will be described later in detail.

Gain codebook 15 stores many candidates (i.e. gain candidates) representing the gain of the input spectrum, and repeats selecting a vector candidate according to control from searching section 17 and outputting a result to error calculating section 16 in order.

Error calculating section 16 calculates error E represented by equation 1, and outputs it to searching section 17. In equation 1, S(k) is the input spectrum, sh(i,k) is the i-th vector candidate, ga(m) is the m-th gain candidate, and FH is the bandwidth of the input spectrum.

$$\begin{matrix}( Equation 1 ) & \\ E = {\sum }_{k = 0}^{FH - 1} {( S ( k ) - ga ( m ) \cdot sh ( i , k ) )}^{2} & [ 1 ]\end{matrix}$$

Searching section 17 sequentially has shape codebook 14 outputting vector candidates and has gain codebook 15 outputting gain candidates. Further, based on the error E outputted from error calculating section 16, searching section 17 searches for the combination that minimizes the error E in a plurality of combinations of vector candidates and gain candidates, and outputs the index i of the vector candidate and the index m of the gain candidate, as the search result, to multiplexing section 18.

Further, upon determining the combination that minimizes the error E, searching section 17 may determine the vector candidate and gain candidate at the same time, determine the vector candidate before determining the gain candidate, or determine the gain candidate before determining the vector candidate.

Further, in error calculating section 16 or searching section 17, it is possible to weight a perceptually important spectrum to give a large weight to and increase the influence of the perceptually important spectrum. In this case, the error E is represented as shown in equation 2. In equation 2, w(k) is the weighting coefficient.

$$\begin{matrix}( Equation 2 ) & \\ E = {\sum }_{k = 0}^{FH - 1} w ( k ) \cdot {( S ( k ) - ga ( m ) \cdot sh ( i , k ) )}^{2} & [ 2 ]\end{matrix}$$

Multiplexing section 18 generates encoded data by multiplexing the dynamic range information, the vector candidate index i and gain candidate index m, and transmits this encoded data to the speech decoding apparatus.

Further, according to the present embodiment, an encoding section is formed with at least error calculating section 16 and searching section 17, for encoding an input spectrum using vector candidates outputted from shape codebook 14.

Next, dynamic range calculating section 12 will be explained in detail.

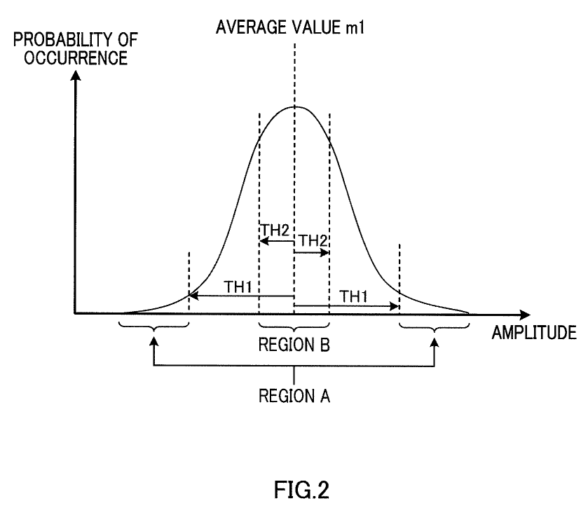

First, an example of a method of calculating the dynamic range according to the present embodiment will be explained using FIG. 2. This figure illustrates the distribution of amplitudes in the input spectrum S (k). When the horizontal axis represents amplitudes and the vertical axis represents the probabilities of occurrence of amplitudes in the input spectrum S (k), distribution similar to the normal distribution shown in FIG. 2 occurs with respect to the average value m1 of the amplitudes as the center.

First, the present embodiment classifies this distribution into the group near the average value m1 (region B in the figure) and the group far from the average value m1 (region A in the figure). Next, the present embodiment calculates the representative values of amplitudes in these two groups, specifically, the average value of the absolute values of the spectral amplitudes included in region A and the average value of the absolute values of the spectral amplitudes included in region B. The average value in region A corresponds to the representative amplitude value of the spectral group having relatively large amplitudes in the input spectrum, and the average value in region B corresponds to the representative amplitude value of the spectral group having relatively small amplitudes in the input spectrum. Further, the present embodiment represents the dynamic range of the input spectrum by the ratio of these two average values.

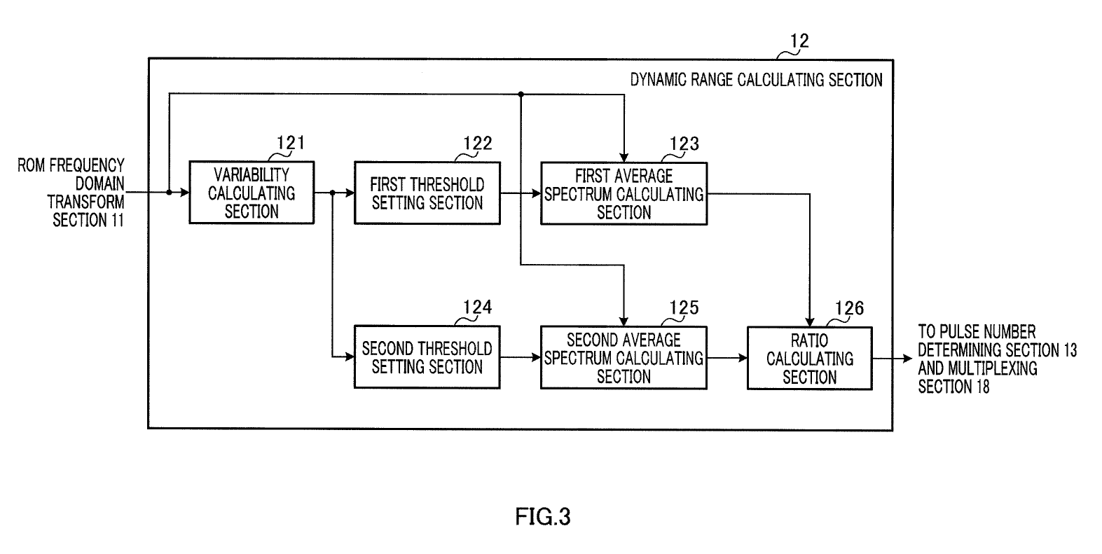

Next, the configuration of dynamic range calculating section 12 will be explained. FIG. 3 illustrates the configuration of dynamic range calculating section 12.

Variability calculating section 121 calculates the variability of the input spectrum from the amplitude distribution in input spectrum S(k) received from frequency domain transform section 11, and outputs the calculated variability to first threshold setting section 122 and second threshold setting section 124. Here, specifically, the variability means the standard deviation σ1 of the input spectrum.

First threshold setting section 122 calculates first threshold TH1 using the standard deviation σ1 calculated in variability calculating section 121, and outputs the result to first average spectrum calculating section 123. Here, the first threshold TH1 refers to the threshold to specify the spectrum of region A where there are relatively large amplitudes in the input spectrum, and is the value calculated by multiplying the standard deviation σ1 by constant a.

First average spectrum calculating section 123 calculates the average value of the amplitudes in the spectrum far from the first threshold TH1, that is, first average spectrum calculating section 123 calculates the average value of amplitudes in the spectrum included in region A (hereinafter “first average value”), and outputs the result to ratio calculating section 126.

To be more specific, first average spectrum calculating section 123 compares the amplitudes in the input spectrum with the value adding the average value m1 of the input spectrum and the first threshold value TH1, (i.e. m1+TH1), and specifies the spectrum of larger amplitudes than m1+Th1 (step 1). Next, first average spectrum calculating section 123 compares the amplitude values in the input spectrum with the value subtracting the first threshold TH1 from the average value m1, (i.e. m1−TH1), and specifies the spectrum of smaller amplitudes than m1−TH (step 2). Further, the average values of the amplitudes of the spectrums specified in steps 1 and 2 are both calculated and outputted to ratio calculating section 126.

On the other hand, second threshold setting section 124 calculates second threshold TH2 using the standard deviation σ1 calculated in variability calculating section 121. The second threshold TH2 is the threshold to specify the spectrum of region B, in which there are relatively low amplitudes in the input spectrum, and is the value calculated by multiplying the standard deviation σ1 by constant b (<a).

Second average spectrum calculating section 125 calculates the average value of amplitudes in the spectrum within the second threshold TH2, that is, second average spectrum calculating section 125 calculates the average value of amplitudes in the spectrum included in region B (hereinafter “second average value”) and outputs the result to ratio calculating section 126. The detailed operations of second average spectrum calculating section 125 are the same as in first average spectrum calculating section 123.

The first average value and second average value calculated as above are the representative values in regions A and B of the input spectrum, respectively.

Ratio calculating section 126 calculates the ratio of the second average value to the first average value (i.e. the ratio of the average value of the spectrum in region B to the average value of the spectrum in region A) as the dynamic range of the input spectrum. Further, ratio calculating section 126 outputs dynamic range information to indicate the calculated dynamic range to pulse number determining section 13 and multiplexing section 18.

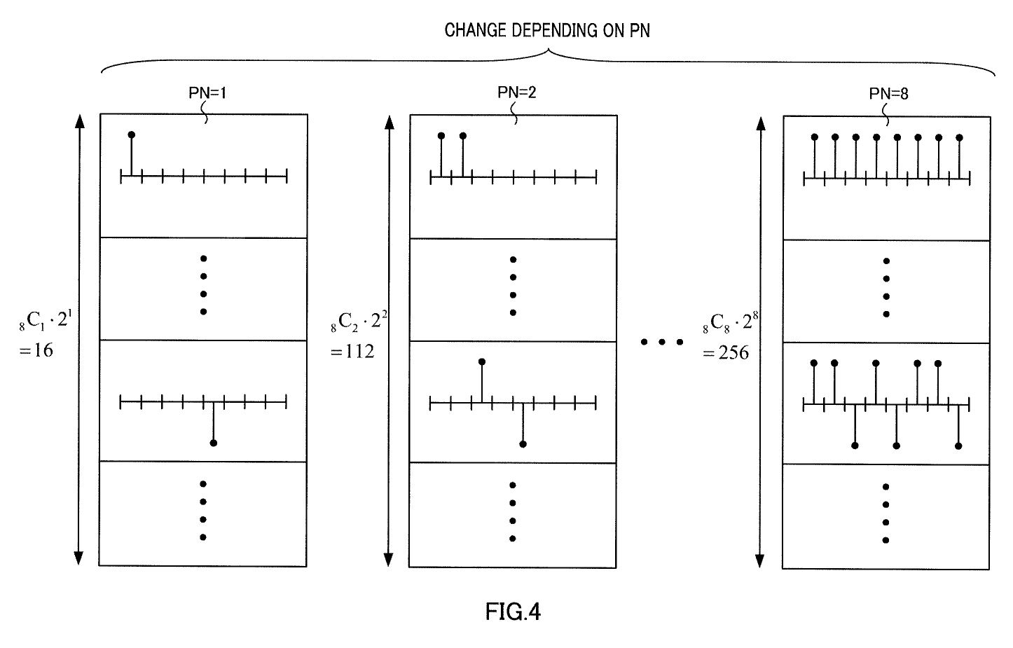

Next, shape codebook 14 will be explained in detail using FIG. 4. FIG. 4 illustrates how the configurations of vector candidates in shape codebook 14 change according to the number of pulses PN determined in pulse number determining section 13. A case will be explained below where the number of dimensions (i.e. the number of elements) M in a vector candidate is eight and the number of pulses PN is one of one to eight.

If the number of pulses PN determined in pulse number determining section 13 is one, one pulse (−1 or +1) is allocated in each vector candidate. Further, in this case, shape codebook 14 repeat selecting a vector candidate from ₈C₁·2¹ (i.e. sixteen) kinds of vector candidates each having one pulse where both or one of location and polarity (i.e. positive or minus sign) is unique, and outputting a result to error calculating section 16.

Further, if the number of pulses PN determined in pulse number determining section 13 is two, a total of two pulses comprised of −1 or +1 are allocated in each vector candidate. Further, in this case, shape codebook 14 repeats selecting a vector candidate from ₈C₂·2² (i.e. 112) kinds of vector candidates each having two pulses in a unique combination of locations and polarities (i.e. positive and minus signs), and outputting a result to error calculating section 16.

Similarly, if the number of pulses PN determined in pulse number determining section 13 is eight, a total of eight pulses comprised of −1 or +1 are allocated in vector candidates. Therefore, in this case, pulses are allocated in all elements in each vector candidate. Further, in this case, shape codebook 14 repeats selecting a vector candidate from ₈C₈·2⁸ (i.e. 256) kinds of vector candidates each having eight pulses in a unique combination of polarities (i.e. positive and negative signs), and outputting a result to error calculating section 16.

Thus, according to the present embodiment, by changing the number of pulses of vector candidates depending on the sharpness of peaks in an input spectrum, specifically, the amount of the dynamic range of the input spectrum, it is possible to change the distribution of pulses in the vector candidates.

Further, as shown in FIG. 4, the number of vector candidates is represented by _{M}C_{PN}·2^{PN}. That is, the number of vector candidates changes according to the number of pulses PN. Here, to represent all vector candidates with a common number of bits not according to the number of pulses PN, it may be preferable to determine in advance the maximum value for the number of vector candidates and limit the number of formed vector candidates within the maximum number.

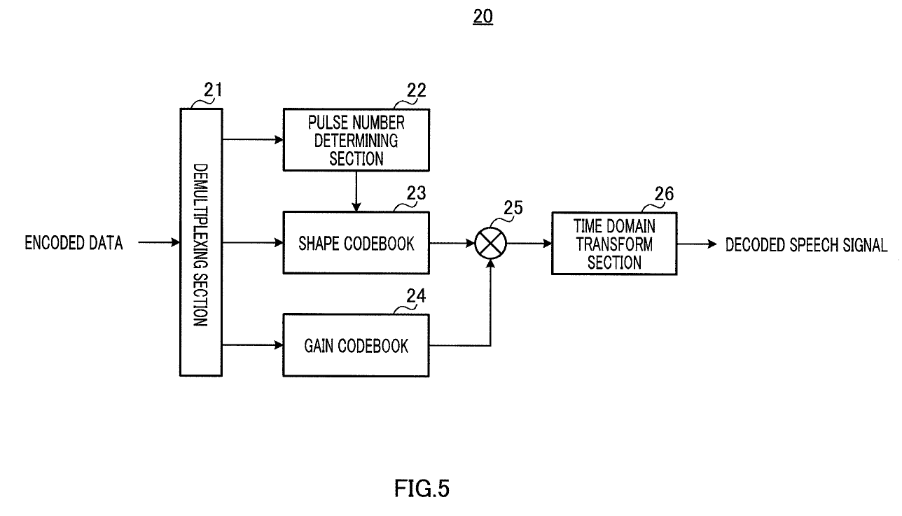

Next, FIG. 5 illustrates the configuration of speech decoding apparatus 20 according to the present embodiment.

In speech decoding apparatus 20 shown in FIG. 5, demultiplexing section 21 demultiplexes encoded data transmitted from speech encoding apparatus 10 into the dynamic range information, vector candidate index i and gain candidate index m. Further, demultiplexing section 21 outputs the dynamic range information to pulse number determining section 22, the vector candidate index i to shape codebook 23 and the gain candidate index m to gain codebook 24.

As in pulse number determining section 13 shown in FIG. 1, pulse number determining section 22 determines the number of pulses in vector candidates that are outputted from shape codebook 23 based on the dynamic range information, and outputs the determined pulses to shape codebook 23.

Shape codebook 23 selects the vector candidate sh(i,k) matching the index i received from demultiplexing section 21, from a plurality kinds of vector candidates each having the same number of pulses in a unique combination, according to the number of pulses determined in pulse number determining section 22, and outputs the result to multiplying section 25.

Gain codebook 24 selects the gain candidate ga(m) matching the index m received from demultiplexing section 21, and outputs the result to multiplying section 25.

Multiplying section 25 multiplies the vector candidate sh(i,k) by the gain candidate ga(m), and outputs frequency domain spectrum ga(m)·sh(i,k), as the multiplying result, to time domain transform section 26.

Time domain transform section 26 transforms the frequency domain spectrum ga(m)·sh(i,k) into a time domain signal, and generates and outputs a decoded speech signal.

Thus, according to the present embodiment, each vector candidate element is one of {−1, 0 and +1}, so that it is possible to significantly reduce the memory capacity a codebook requires. Further, the present embodiment changes the number of pulses in vector candidates according to the sharpness of peaks in the spectrum of an input speech signal, so that it is possible to generate an optimal vector candidate in accordance with the characteristics of the input speech signal formed with elements {−1, 0 and +1}. Therefore, according to the present embodiment, it is possible to reduce an increase in the bit rate and sufficiently suppress the quantization distortion. By this means, in a decoding apparatus, it is possible to acquire decoded signals of high quality.

Further, the present embodiment uses the dynamic range of a spectrum as an indicator to indicate the sharpness of peaks in the spectrum, so that it is possible to show sharpness of the peaks in the spectrum quantitatively and accurately.

Further, although standard deviation is used as variability in the present embodiment, it is equally possible to use other indicators.

Further, an example case has been described with the present embodiment where speech decoding apparatus 20 receives and process encoded data transmitted from speech encoding apparatus 10, it is equally possible to receive and process encoded data outputted from an encoding apparatus that has other configurations and that can generate the same encoded data as the encoded data outputted as above.

### Embodiment 2

The present embodiment differs from Embodiment 1 in allocating pulses in vector candidates only in the vicinity of the frequencies of integral multiples of the pitch frequency of an input speech signal.

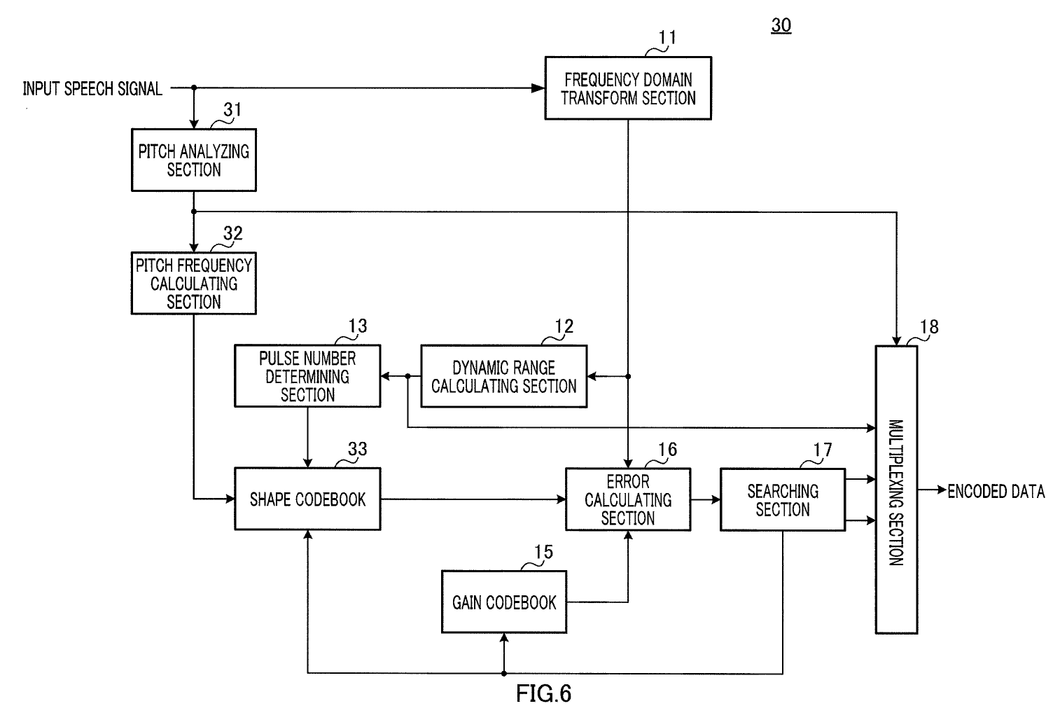

FIG. 6 illustrates the configuration of speech encoding apparatus 30 according to the present embodiment. Further, in FIG. 6, the same components as in FIG. 1 will be assigned the same reference numerals and their explanations will be omitted.

In speech encoding apparatus 30 shown in FIG. 6, pitch analysis section 31 calculates the pitch period of an input speech signal and outputs the result to pitch frequency calculating section 32 and multiplexing section 18.

Pitch frequency calculating section 32 calculates the pitch frequency, which is a frequency domain parameter, from the pitch period, which is a time domain parameter, and outputs the result to shape codebook 33. When the pitch period is PT and the sampling rate of the input speech signal is FS, the pitch frequency PF is calculated according to equation 3.

$$\begin{matrix}( Equation 3 ) & \\ PF = {( \frac{PT}{FS} )}^{- 1} = \frac{FS}{PT} & [ 3 ]\end{matrix}$$

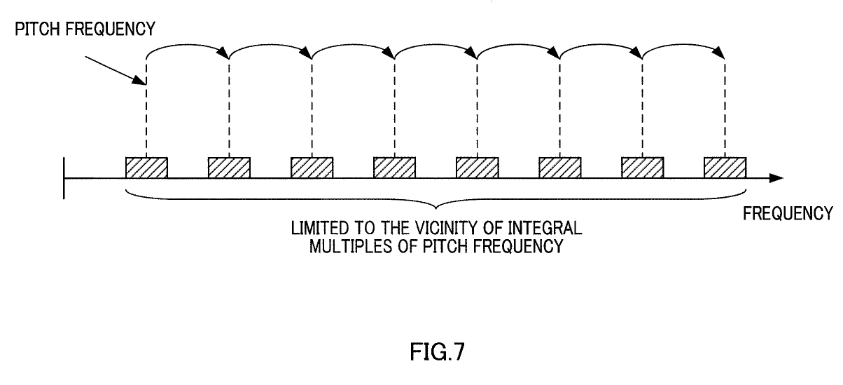

There is a high possibility that there are peaks in the input spectrum in the vicinity of the frequencies of integral multiples of the pitch frequency, and, consequently, as shown in FIG. 7, the positions to allocate pulses in vector candidates are limited to the vicinity of the frequencies of integral multiples of the pitch frequency in shape codebook 33. That is, when pulses are allocated in vector candidates as shown in above-noted FIG. 4, pulses are allocated only in the vicinity of the frequencies of integral multiples of the pitch frequency in shape codebook 33. Therefore, shape codebook 33 outputs vector candidates, in which pulses are allocated only in the vicinity of the frequencies of integral multiples of the pitch frequency of the input speech signal, to error calculating section 16.

Further, multiplexing section 18 generates encoded data by multiplexing the dynamic range information, vector candidate index i, gain candidate index m and pitch period PT.

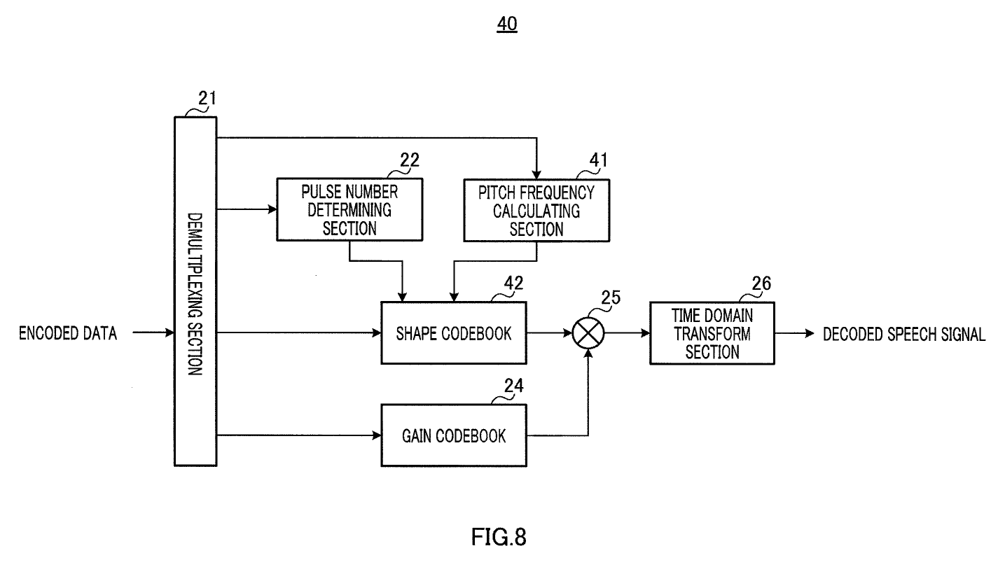

Next, FIG. 8 illustrates the configuration of speech decoding apparatus 40 according to the present embodiment. Further, in FIG. 8, the same components as in FIG. 5 will be assigned the same reference numerals and their explanations will be omitted.

Speech decoding apparatus 40 shown in FIG. 8 receives encoded data transmitted from speech encoding apparatus 30. In addition to the process in Embodiment 1, demultiplexing section 21 outputs the pitch period PT separated from the encoded data, to pitch frequency calculating section 41.

Pitch frequency calculating section 41 calculates pitch frequency PF and outputs it to shape codebook 42 in the same way as in pitch frequency calculating section 32.

Shape codebook 42 limits the positions to allocate pulses according to the pitch frequency PF, generates the vector candidate sh(i,k) matching the index i received from demultiplexing section 21 according to the number of pulses determined in pulse number determining section 22, and outputs the result to multiplying section 25.

As described above, according to the present embodiment, the positions to allocate pulses are limited to positions, in which there is a high possibility that peaks in an input spectrum are present, in vector candidates, so that it is possible to maintain speech quality and reduce allocation information of pulses and bit rate.

Further, although an example has been explained with the present embodiment where speech decoding apparatus 40 receives encoded data transmitted from speech encoding apparatus 30 and processes the encoded data, it is equally possible to receive and process encoded data outputted from an encoding apparatus that has other configurations and that can generate the same encoded data as the encoded data outputted as above.

### Embodiment 3

The present embodiment differs from Embodiment 1 in controlling the distribution of pulses of vector candidates by changing the dispersion level of a dispersion vector according to the sharpness of peaks in an input spectrum.

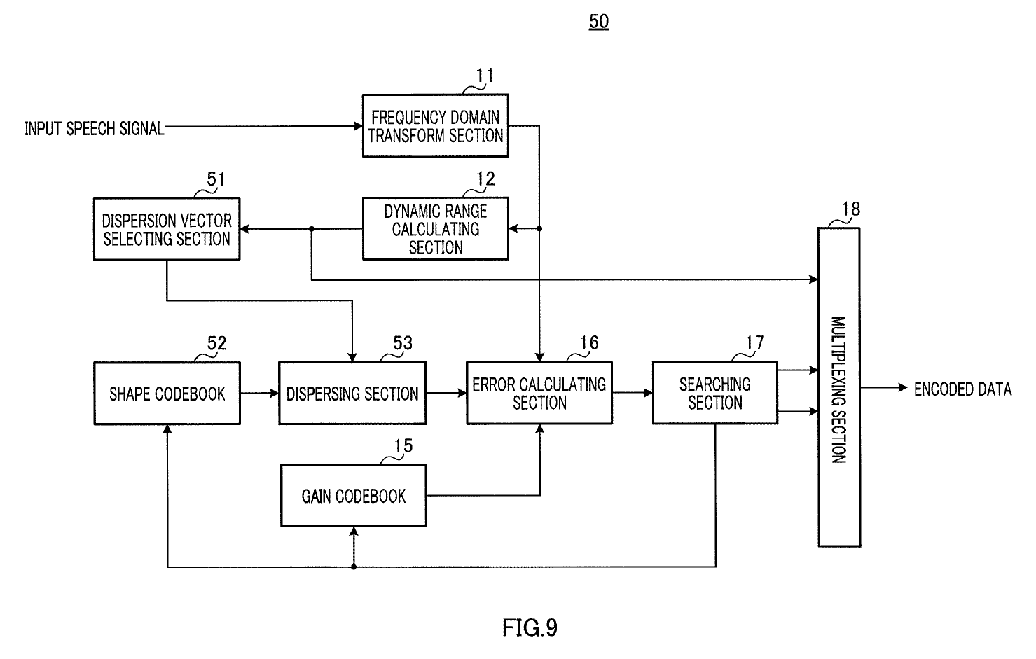

FIG. 9 illustrates the configuration of speech encoding apparatus 50 according to the present embodiment. Further, in FIG. 9, the same components as in FIG. 1 will be assigned the same reference numerals and their explanations will be omitted.

Dynamic range calculating section 12 calculates the dynamic range of an input spectrum as an indicator to indicate sharpness of peaks in the input spectrum in the same way as in Embodiment 1, and outputs dynamic range information to dispersion vector selecting section 51 and multiplexing section 18.

Dispersion vector selecting section 51 controls the distribution of pulses in vector candidates by changing the dispersion level of a dispersion vector to be used for dispersion in dispersing section 53, according to the sharpness of peaks in an input spectrum. To be more specific, dispersion vector selecting section 51 stores a plurality of dispersion vectors of respective dispersion levels, and selects a dispersion vector disp(j) based on the dynamic range information and outputs it to dispersing section 53. In this case, dispersion vector selecting section 51 selects a dispersion vector of the lower dispersion level when the dynamic range of the input spectrum is higher.

Shape codebook 52 outputs frequency domain vector candidates to dispersing section 53. Shape codebook 52 repeats selecting a vector candidate sh(i,k) from a plurality kinds of vector candidates according to control from searching section 17, and outputting a result to dispersing section 53. Further, a vector candidate element is one of {−1, 0 and +1}.

Dispersing section 53 disperses the vector candidate sh(i,k) by convolving the dispersion vector disp(j) with the vector candidate sh(i,k), and outputs the dispersed vector candidate shd(i,k) to error calculating section 16. The dispersed vector candidate shd(i,k) is represented as shown in equation 4. Here, J represents the order of the dispersion vector.

$$\begin{matrix}( Equation 4 ) & \\ shd ( i , k ) = {\sum }_{j = 0}^{J - 1} sh ( i , k - j ) \cdot disp ( j ) & [ 4 ]\end{matrix}$$

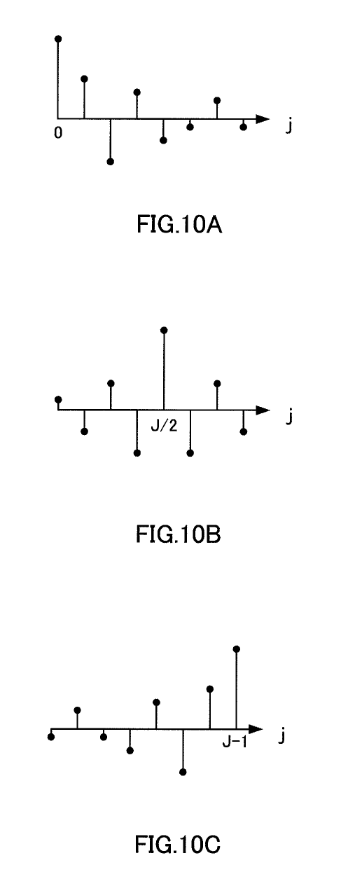

Here, the dispersion vector disp(j) can form an arbitrary shape. For example, it is possible to form a shape having the maximum value in the location of j=0 as shown in FIG. 10A, a shape having the maximum value in the location of j=j/2 as shown in FIG. 10B, or a shape having the maximum value in the location of j=j−1 as shown in FIG. 10C.

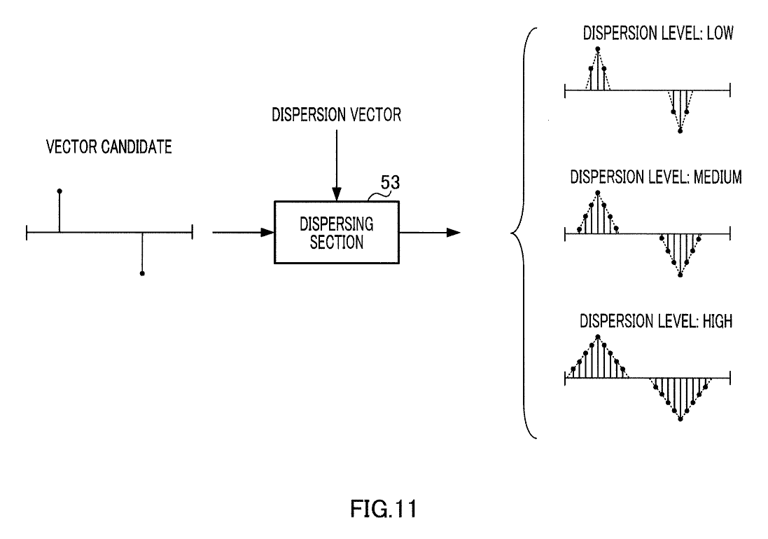

Next, FIG. 11 illustrates a state where the same vector candidate is dispersed by a plurality of dispersion vectors of respective dispersion levels. As shown in FIG. 11, by dispersing the vector candidate using dispersion vectors of respective dispersion levels, it is possible to change a dispersion level of energy in the element sequence of the vector candidate (i.e. a dispersion level in the vector candidate). That is, when a dispersion vector of a higher dispersion level is used, it is possible to increase a dispersion level of energy in the vector candidate (i.e. reduce a concentration level of energy in a vector candidate). In other words, when a dispersion vector of a lower dispersion level is used, it is possible to reduce a dispersion level of energy in the vector candidate (i.e. it is possible to increase a concentration level of energy in the vector candidate). According to the present embodiment, as described above, a dispersion vector of a lower dispersion level is selected when the dynamic range of an input spectrum increases, so that a dispersion level of energy in a vector candidate that is outputted to error calculating section 16 is lower when the dynamic range of the input spectrum is higher.

Thus, the present embodiment changes the dispersion level of a dispersion vector according to the sharpness of peaks in an input spectrum, specifically, according to the amount of the dynamic range of an input spectrum, thereby changing the distribution of pulses in vector candidates.

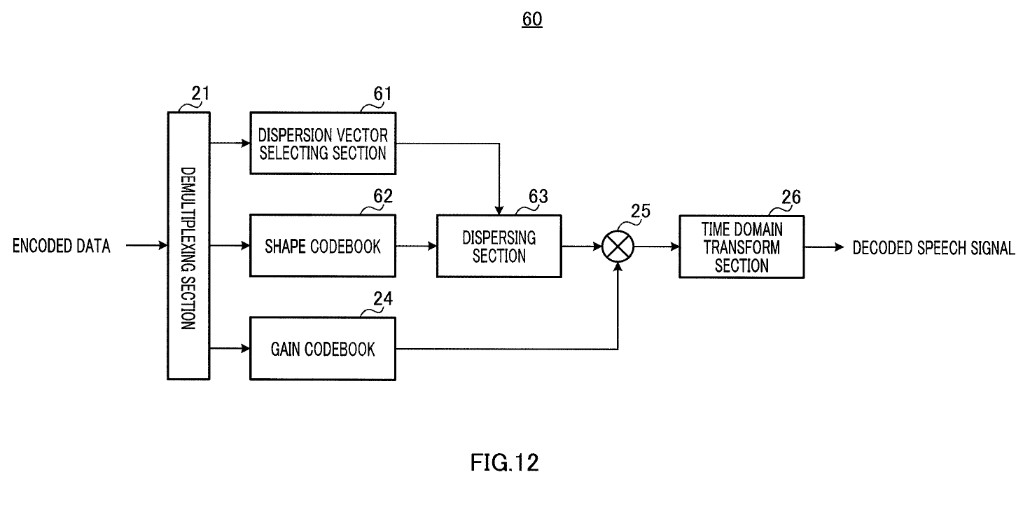

Next, FIG. 12 illustrates the configuration of speech decoding apparatus 60 according to the present embodiment. Further, in FIG. 12, the same components as in FIG. 5 will be assigned the same reference numerals and their explanations will be omitted.

Speech decoding apparatus 60 shown in FIG. 12 receives encoded data transmitted from speech encoding apparatus 50. Demultiplexing section 21 demultiplexes the inputted encoded data into the dynamic range information, vector candidate index i and gain candidate index m, and outputs the dynamic information to dispersion vector selecting section 61, the vector candidate index i to shape codebook 62, and the gain candidate index m to gain codebook 24.

Dispersion vector selecting section 61 stores a plurality of dispersion vectors of respective dispersion levels, and selects dispersion vector disp(j) based on the dynamic range information and outputs it to dispersing section 63 in the same way as in dispersion vector selecting section 51 shown in FIG. 9.

Shape codebook 62 selects the vector candidate sh(i,k) matching the index i received from demultiplexing section 21, and outputs the result to dispersing section 63.

Dispersing section 63 disperses the vector candidate sh(i,k) by convolving the dispersion vector disp(j) with the vector candidate sh(i,k), and outputs the dispersed vector candidate shd(i,k) to multiplying section 25.

Multiplying section 25 multiplies the dispersed vector candidate shd(i,k) by the gain candidate ga(m), and outputs the spectrum ga(m)·shd(i,k) in the frequency domain, as the multiplying result, to time domain transform section 26.

Thus, according to the present embodiment, as in Embodiment 1, each vector candidate element is one of {−1, 0 and +1}, so that it is possible to significantly reduce the memory capacity a codebook requires. Further, the present embodiment changes the dispersing level of energy in a vector candidate by changing the dispersion level of a dispersion vector according to the sharpness of peaks in the spectrum of an input speech signal, so that it is possible to generate an optimal vector candidate in accordance with the characteristics of the input speech signal from elements {−1, 0 and +1}. Therefore, according to the present embodiment, in a speech encoding apparatus employing a configuration for dispersing a vector candidate using a dispersion vector, it is possible to suppress an increase in the bit rate and sufficiently suppress quantization distortion. By this means, in the decoding apparatus, it is possible to acquire decoded signals of high quality.

Further, basically, dispersion vector selecting section 61 stores a plurality of the same dispersion vectors as in dispersion vector selecting section 51. However, on the decoding side, for example, if processing is performed with respect to sound quality and so on, it is possible to store different dispersion vectors from the encoding side. Further, dispersion vector selecting sections 51 and 61 may employ a configuration for generating required dispersion vectors inside, instead of storing a plurality of dispersion vectors.

Further, an example has been explained with the present embodiment where speech decoding apparatus 60 receives encoded data transmitted from speech encoding apparatus 50 and processes the encoded data, it is equally possible to receive and process encoded data outputted from an encoding apparatus that has other configurations and that can generate the same encoded data as the encoded data outputted as above.

### Embodiment 4

A case will be explained with the present embodiment where the present invention is applied to scalable coding using a plurality of layers.

In the following explanation, the frequency band 0≦k<FL will be referred to as “lower band,” the frequency band FL≦k<FH is referred to as “higher band,” and the frequency band 0≦k<FH will be referred to as “full band.” Further, the frequency band FL≦k<FH is acquired by band extension based on the lower band, and therefore can be referred to as “extended band.” Further, in the following explanation, scalable coding to provide the first to third layers in a hierarchical manner will be explained as an example. The lower band (0≦k<FL) of an input speech signal is encoded in the first layer, the signal band of the first layer decoded signal is extended to the full band (0≦k<FH) at lower bit rate in the second layer, and the error components between the input speech signal, and the second layer decoded signal are encoded in the third layer.

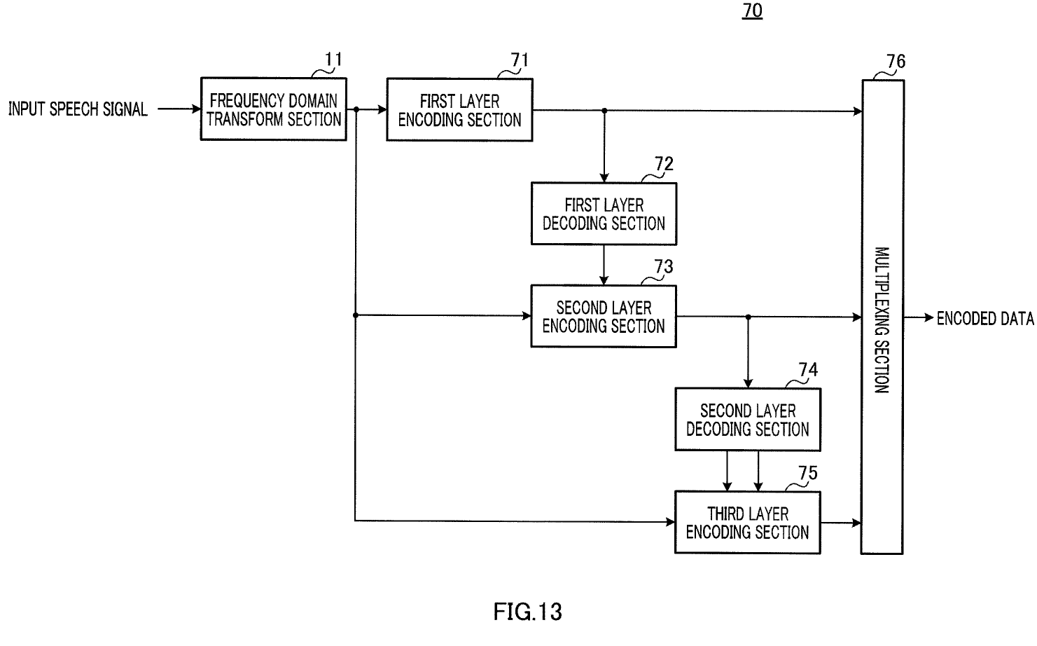

FIG. 13 illustrates the configuration of speech encoding apparatus 70 according to the present embodiment. Further, in FIG. 13, the same components as in FIG. 1 will be assigned the same reference numerals and their explanations will be omitted.

In speech encoding apparatus 70 shown in FIG. 13, an input spectrum outputted from frequency domain transform section 11 is inputted in first layer encoding section 71, second layer encoding section 73 and third layer encoding section 75.

First layer encoding section 71 encodes the lower band of the input spectrum, and outputs the first layer encoded data acquired by this encoding to first layer decoding section 72 and multiplexing section 76.

First layer decoding section 72 generates the first layer decoded spectrum by decoding the first layer encoded data and outputs the first layer decoded spectrum to second layer encoding section 73. Further, first layer decoding section 72 outputs the first layer decoded spectrum that is not transformed into a time domain signal.

Second layer encoding section 73 encodes the higher band of the input spectrum outputted from frequency domain transform section 11, using the first layer decoded spectrum acquired in first layer decoding section 72, and outputs the second layer encoded data acquired by this encoding to second layer decoding section 74 and multiplexing section 76. To be more specific, second layer encoding section 73 estimates the higher band of the input spectrum by a pitch filtering process, using the first decoded spectrum as the filter state of the pitch filter. In this case, second layer encoding section 73 estimates the higher band of the input spectrum such that the harmonic structure of the spectrum does not collapse. Further, second layer encoding section 73 encodes filter information of the pitch filter. Second layer encoding section 73 will be described later in detail.

Second layer decoding section 74 generates a second layer decoded spectrum and acquires dynamic range information of the input spectrum by decoding the second layer encoded data, and outputs the second layer decoded spectrum and dynamic range information to third layer encoding section 75.

Third layer encoding section 75 generates third layer encoded data using the input spectrum, second layer decoded spectrum and dynamic range information, and outputs the third layer encoded data to multiplexing section 76. Third layer encoding section 75 will be described later in detail.

Multiplexing section 76 generates encoded data by multiplexing the first layer encoded data, second layer encoded data and third layer encoded data, and transmits this encoded data to the speech decoding apparatus.

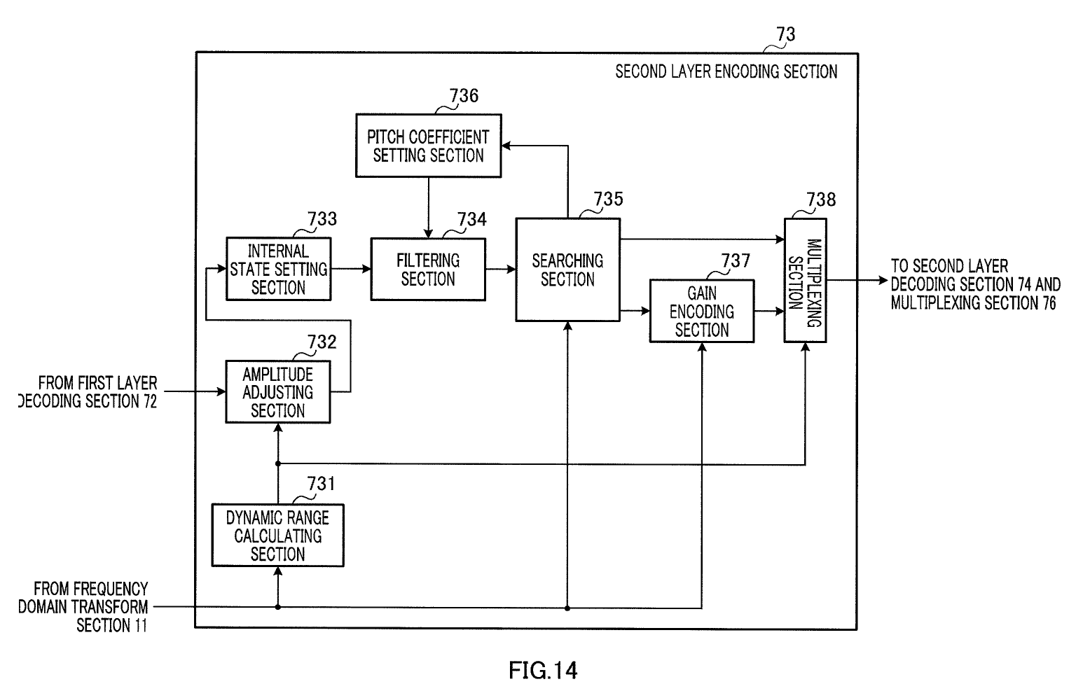

Next, second layer encoding section 73 will be explained below in detail. FIG. 14 illustrates the configuration of second layer encoding section 73.

In second layer encoding section 73 shown in FIG. 14, dynamic range calculating section 731 calculates the dynamic range of the higher band of the input spectrum as an indicator to indicate sharpness of peaks in the input spectrum, and outputs dynamic range information to amplitude adjusting section 732 and multiplexing section 738. Further, the method of calculating the dynamic range is as described in Embodiment 1.

Amplitude adjusting section 732 adjusts the amplitude of the first layer decoded spectrum such that the dynamic range of the first layer decoded spectrum is similar to the dynamic range of the higher band of the input spectrum, using the dynamic range information, and outputs the first layer decoded spectrum after amplitude adjustment to internal state setting section 733.

Internal state setting section 733 sets the filter internal state that is used in filtering section 734, using the first layer decoded spectrum after amplitude adjustment.

Pitch coefficient setting section 736 gradually and sequentially changes the pitch coefficient T, in the predetermined search range between Tₘᵢₙ and Tₘₐₓ under the control from searching section 735, and sequentially outputs the pitch coefficients T to filtering section 734.

Filtering section 734 calculates estimation value S2′ (k) of the input spectrum by filtering the first layer decoded spectrum after amplitude adjustment, based on the filter internal state set in internal state setting section 733 and the pitch coefficients T outputted from pitch coefficient setting section 736. This filtering process will be described later in detail.

Searching section 735 calculates the similarity, which is a parameter to indicate the similarity between the input spectrum S2(k) received from frequency domain transform section 11 and the estimation value S2′ (k) of the input spectrum received from filtering section 734. This process of calculating the similarity is performed every time the pitch coefficient T is given from pitch coefficient setting section 736 to filtering section 734, and the pitch coefficient (optimal pitch coefficient) T′ where the calculated similarity is maximum, is outputted to multiplexing section 738 (where T′ is in the range between Tₘᵢₙ to Tₘₐₓ). Further, searching section 735 outputs the estimation value S2′ (k) of the input spectrum generated using this pitch coefficient T′, to gain encoding section 737.

Gain encoding section 737 calculates gain information about the input spectrum S2(k). Further, an example case will be explained below where gain information is represented by the spectrum power per subband and where the frequency band FL≦k<FH is divided into J subbands. In this case, the spectrum power B(j) of the j-th subband is represented by equation 5. In equation 5, BL(j) represents the lowest frequency in the j-th subband, and BH(j) represents the highest frequency in the j-th subband. The subband information of the input spectrum calculated as above is used as gain information on the input spectrum.

$$\begin{matrix}( Equation 5 ) & \\ B ( j ) = {\sum }_{k = BL ( j )}^{BH ( j )} S 2 {( k )}^{2} & [ 5 ]\end{matrix}$$

Further, gain encoding section 737 calculates the subband information B′ (j) about the estimation value S2′ (k) of the input spectrum according to equation 6, and calculates variation V(j) per subband according to equation 7.

$$\begin{matrix}( Equation 6 ) & \\ {B}^{′} ( j ) = {\sum }_{k = BL ( j )}^{BH ( j )} S {2}^{′} {( k )}^{2} & [ 6 ] \\ ( Equation 7 ) & \\ V ( j ) = \sqrt{\frac{B ( j )}{{B}^{′} ( j )}} & [ 7 ]\end{matrix}$$

Further, gain encoding section 737 encodes the variation V(j) and obtains variation V_{q}(j) after encoding, and outputs its index to multiplexing section 738.

Multiplexing section 738 generates second layer encoded data by multiplexing the dynamic range information received from dynamic range calculating section 731, the optimal pitch coefficient T′ received from searching section 735 and the index of the variation V_{q}(j) received from gain encoding section 737, and outputs the second layer encoded data to multiplexing section 76 and second layer decoding section 74. Further, it is possible to employ a configuration directly inputting the dynamic range information outputted from dynamic range calculating section 731, the optimal pitch coefficient T′ outputted from searching section 735 and the index of the variation V(j) outputted from gain encoding section 737, in second layer decoding section 74 and multiplexing section 76, without multiplexing section 738, and multiplexing these with the first layer encoded data and third layer encoded data in multiplexing section 76.

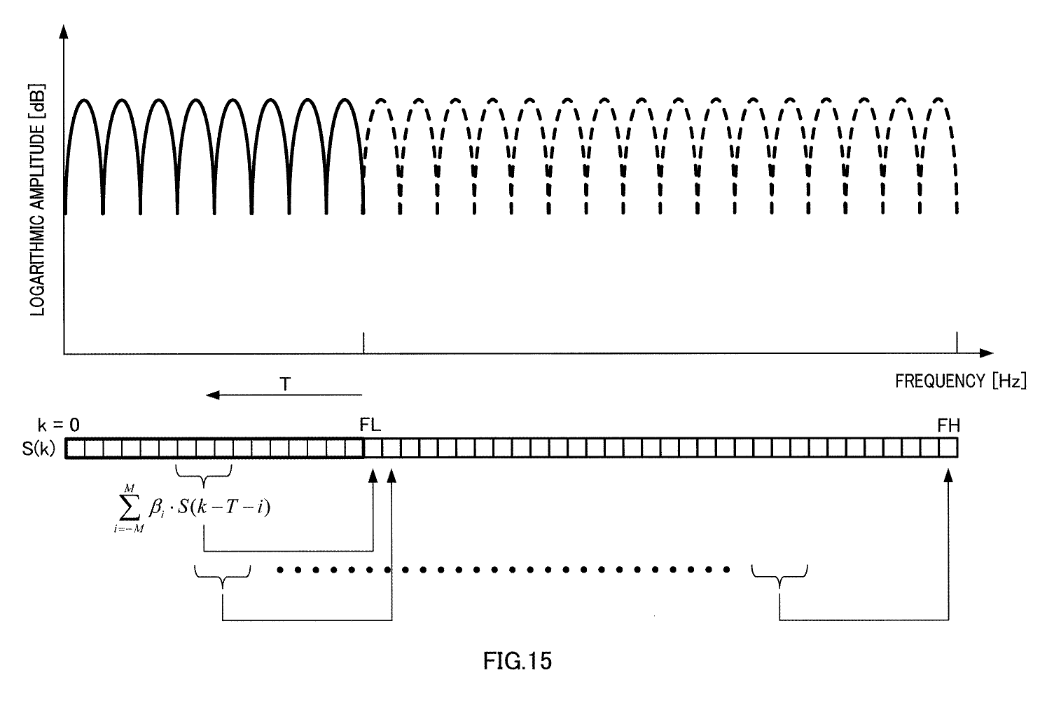

Here, the filtering process in filtering section 734 will be explained below. FIG. 15 illustrates a state where filtering section 734 generates the spectrum of the band FL≦k<FH using the pitch coefficient T received from pitch coefficient setting section 736. Here, the spectrum of the full frequency band (0≦k<FH) will be referred to as “S(k)” for ease of explanation, and the filter function shown in equation 8 will be used. In this equation, T represents the pitch coefficient given from pitch coefficient setting section 736, and M is 1.

$$\begin{matrix}( Equation 8 ) & \\ P ( z ) = \frac{1}{1 - {\sum }_{i = - M}^{M} {β}_{i} {z}^{- T + i}} & [ 8 ]\end{matrix}$$

The band 0≦k<FL in S(k) accommodates the first layer decoded spectrum S1(k) as the internal state of filter. On the other hand, the band FL≦k<FH in S(k) accommodates estimation value S2′ (k) of the input spectrum calculated in the following steps.

By the filtering process, the spectrums βᵢ·S(k-T-i) are calculated, which are acquired by multiplying the nearby spectrums S(k-T-i) that are each i apart from frequency spectrum S(k-T) that is T lower than k, by a predetermined weighting coefficient βᵢ, and the spectrum adding all the resulting spectrums, that is, the spectrum represented by equation 9, is assigned to S2′ (k). By performing the above calculation by changing frequency k in order from the lowest frequency (k=FL) in the range of FL≦k<FH, the estimation value S2′ (k) in the band FL≦k<FH of the input spectrum is calculated.

$$\begin{matrix}( Equation 9 ) & \\ S {2}^{′} ( k ) = {\sum }_{i = - 1}^{1} {β}_{i} \cdot S ( k - T - i ) & [ 9 ]\end{matrix}$$

The above filtering process is performed by zero-clearing S(k) in the FL≦k<FH range every time pitch coefficient setting section 736 gives the pitch coefficient T. That is, S(k) is calculated and outputted to searching section 735 every time the pitch coefficient T changes.

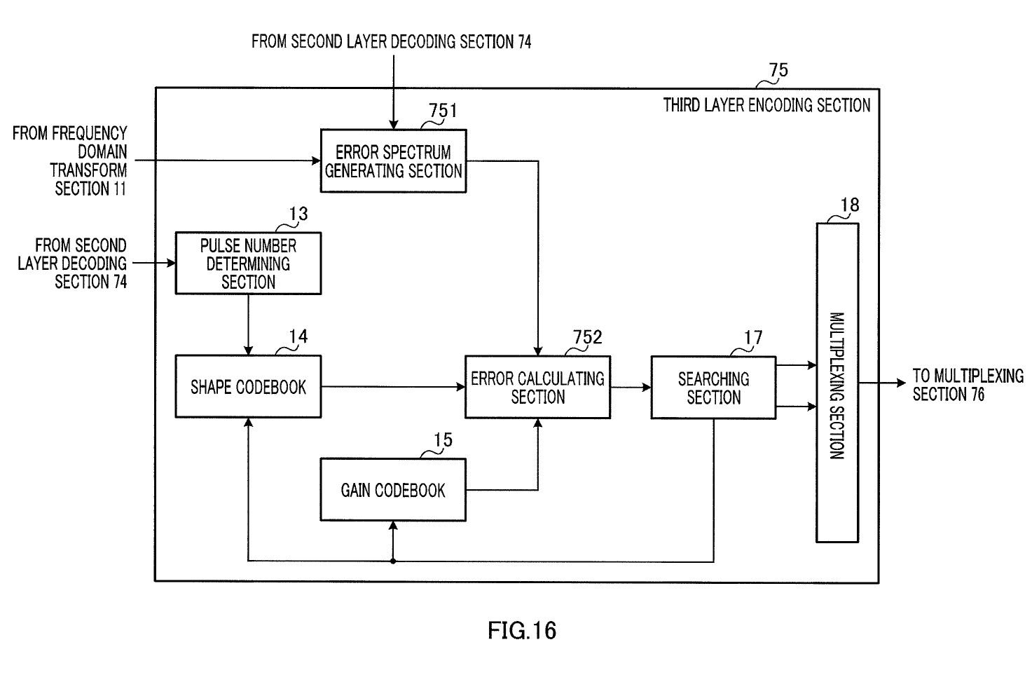

Next, third layer encoding section 75 will be explained below. FIG. 16 illustrates the configuration of third layer encoding section 75. Further, in FIG. 16, the same components as in FIG. 1 will be assigned the same reference numerals and their explanations will be omitted.

In third layer encoding section 75 shown in FIG. 16, pulse number determining section 13 received the dynamic range information included in the second layer encoded data, from second layer decoding section 74. This dynamic range information is outputted from dynamic range calculating section 731 of second layer encoding section 73. As in Embodiment 1, pulse number determining section 13 determines the number of pulses in vector candidates that are outputted from shape codebook 14, and outputs the determined number of pulses to shape codebook 14. Here, pulse number determining section 13 reduces the number of pulses when the dynamic range of the input spectrum is higher.

Error spectrum generating section 751 calculates an error spectrum, which is a signal to represent the difference between the input spectrum S2(k) and the second layer decoded spectrum S3(k). Here, the error spectrum Se(k) is calculated according to equation 10.

(Equation 10)

Se(k)=S2(k)−S3(k) (0≦k<FH) [10]

Further, the spectrum of the higher band in the second layer decoded spectrum is a pseudo spectrum, and, consequently, the shape of the spectrum may differ from the input spectrum significantly. Therefore, it is possible to use, as the error spectrum, the difference between the input spectrum and the second layer decoded spectrum when the spectrum of the higher band in the second layer decoded spectrum is zero. In this case, the error spectrum Se(k) is calculated as shown in equation 11.

$$\begin{matrix}( Equation 11 ) & \\ Se ( k ) = \{ \begin{matrix}S 2 ( k ) - S 3 ( k ) & ( 0 \leq k < FL ) \\ S 2 ( k ) & ( FL \leq k < FH )\end{matrix} & [ 11 ]\end{matrix}$$

The error spectrum calculated as above in error spectrum generating section 751 is outputted to error calculating section 752.

Error calculating section 752 calculates error E by replacing the input spectrum S(k) with the error spectrum Se(k) in equation 1, and outputs the error E to searching section 17.

Multiplexing section 18 generates third layer encoded data by multiplexing the vector candidate index i and gain candidate index m outputted from searching section 17, and outputs the third layer encoded data to multiplexing section 76. Further, without multiplexing section 18, it is possible to directly input the vector candidate index i and gain candidate index m in multiplexing section 76, and multiplex these indices with the first layer encoded data and second layer encoded data, respectively.

Further, according to the present embodiment, an encoding section is formed with at least error calculating section 752 and searching section 17, for encoding an error spectrum using vector candidates outputted from shape encoding section 14.

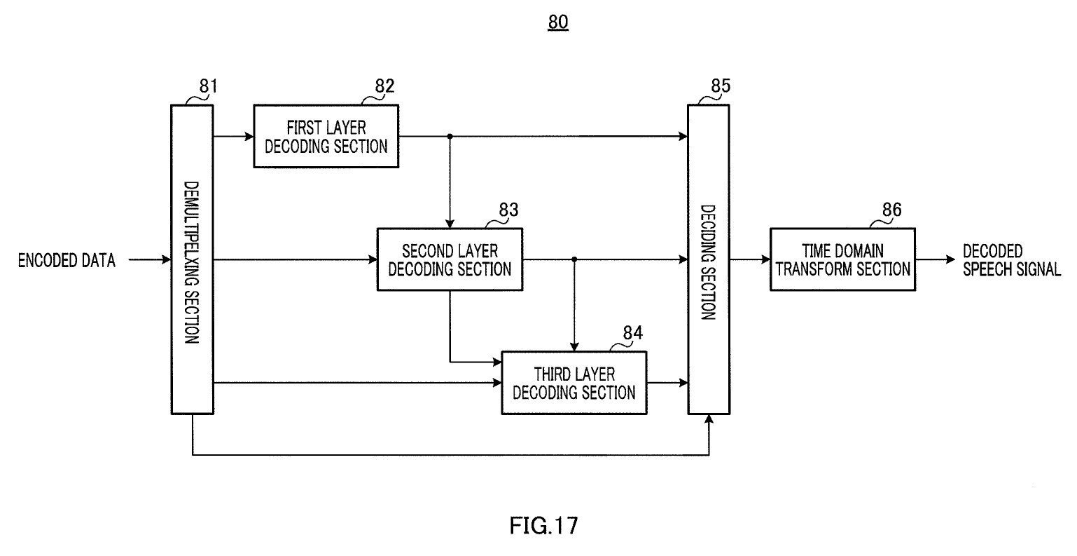

Next, FIG. 17 illustrates the configuration of speech decoding apparatus 80 according to the present embodiment.

In speech decoding apparatus 80 shown in FIG. 17, demultiplexing section 81 demultiplexes the encoded data transmitted from speech encoding apparatus 70, into the first layer encoded data, second layer encoded data and third layer encoded data. Further, demultiplexing section 81 outputs the first layer encoded data to first layer decoding section 82, the second layer encoded data to second layer decoding section 83, and the third layer encoded data to third layer decoding section 84. Further, demultiplexing section 81 outputs layer information to indicate encoded data of which layer is included in the encoded data transmitted from speech encoding apparatus 70, and outputs the layer information to deciding section 85.

First layer decoding section 82 generates a first layer decoded spectrum by performing a decoding process for the first layer encoded data, and outputs the first layer decoded spectrum to second layer decoding section 83 and deciding section 85.

Second layer decoding section 83 generates a second layer decoded spectrum using the second layer encoded data and first layer decoded spectrum, and outputs the second layer decoded spectrum to third layer decoding section 84 and deciding section 85. Further, second layer decoding section 83 outputs dynamic range information acquired by decoding the second layer encoded data, to third layer decoding section 84. Further, second layer decoding section 83 will be described later in detail.

Third layer decoding section 84 generates a third layer decoded spectrum using the second layer decoded spectrum, dynamic range information and third layer encoded data, and outputs the third layer decoded spectrum to deciding section 85.

Here, the second layer encoded data and third layer encoded data may be discarded in somewhere in the transmission paths. Therefore, based on the layer information outputted from demultiplexing section 81, deciding section 85 decides whether or not the encoded data transmitted from speech encoding apparatus 70 includes second layer encoded data and third layer encoded data. Further, if the encoded data does not include the second layer encoded data and third layer encoded data, deciding section 85 outputs the first layer decoded spectrum to time domain transform section 86. However, in this case, to match the order of the first layer decoded spectrum with the order of the decoded spectrum in a case where the second layer encoded data and third layer encoded data is included, deciding section 85 extends the order of the first layer decoded spectrum to FH and outputs the spectrum of the band between FL and FH as zero. Further, if the encoded data does not include third layer encoded data, deciding section 85 outputs the second layer decoded spectrum to time domain transform section 86. By contrast, if the encoded data includes the first layer encoded data, second layer encoded data and third layer encoded data, deciding section 85 outputs the third layer decoded spectrum to time domain transform section 86.

Time domain transform section 86 generates a decoded speech signal by transforming the decoded spectrum outputted from deciding section 85 into a time domain signal.

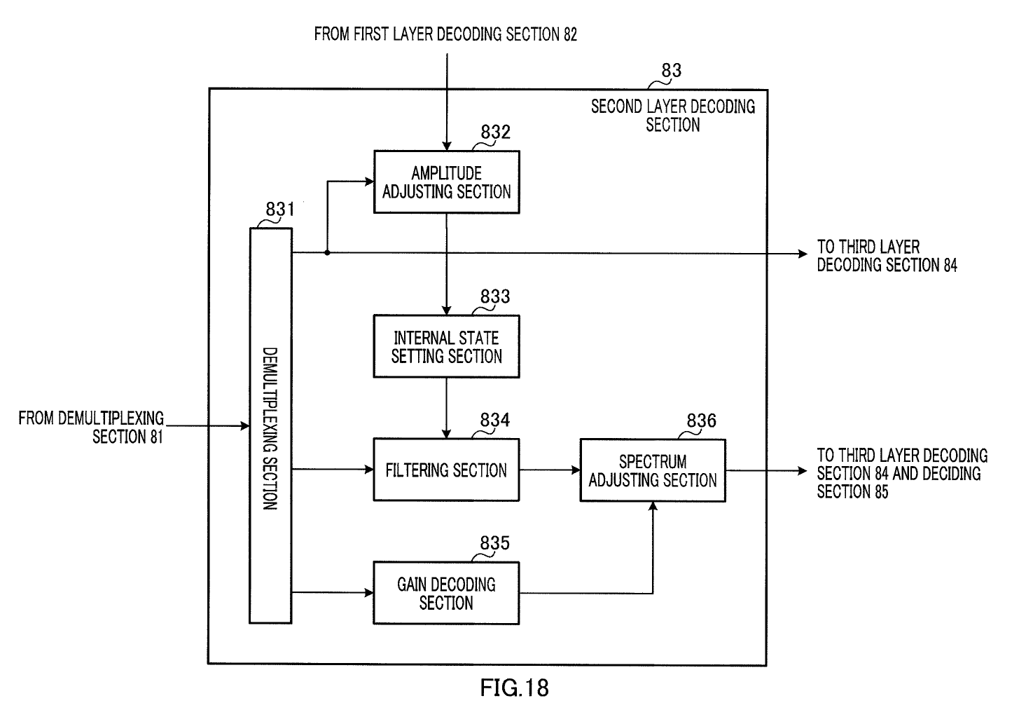

Next, second layer decoding section 83 will be explained in detail. FIG. 18 illustrates the configuration of second layer decoding section 83.

In second layer decoding section 83 shown in FIG. 18, demultiplexing section 831 demultiplexes the second layer encoded data into the dynamic range information, the filtering coefficient information (about the optimal pitch coefficient T′) and the gain information (about index of variation V(J)), and outputs the dynamic range information to amplitude adjusting section 832 and third layer decoding section 84, the filtering coefficient information to filtering section 834, and the gain information to gain decoding section 835. Further, without demultiplexing section 831, it is possible to demultiplex the second layer encoded data and input the resulting information to second layer decoding section 83.

As in amplitude adjusting section 732 shown in FIG. 14, amplitude adjusting section 832 adjusts the amplitude of the first layer decoded spectrum using the dynamic range information, and outputs the adjusted first layer decoded spectrum to internal state setting section 833.

Internal state setting section 833 sets the filter internal state that is used in filtering section 834, using the adjusted first layer decoded spectrum.

Filtering section 834 filters the adjusted first layer decoded spectrum, based on the filter internal state set in internal state setting section 833 and the pitch coefficient T′ received from demultiplexing section 831, to calculate the estimation value S2′ (k) of the input spectrum. Filtering section 834 uses the filter function shown in equation 8.

Gain decoding section 835 decodes the gain information received from demultiplexing section 831, calculates variation V_{q}(j) by encoding the variation V(j), and outputs the result to spectrum adjusting section 836.

Spectrum adjusting section 836 multiplies the decoded spectrum S′ (k) received from filtering section 834 by the variation V_{q}(j) of each subband received from gain decoding section 835 according to equation 12, thereby adjusting the shape of the spectrum of the frequency band FL≦k<FH in the decoded spectrum S′ (k) and generating adjusted decoded spectrum S3(k). This adjusted decoded spectrum S3(k) is outputted to third layer decoding section 84 and deciding section 85 as a second layer decoded spectrum.

(Equation 12)

S3(k)=S′(k)·V_{q}(j) (BL(j)≦k≦BH(j), for all j) [12]

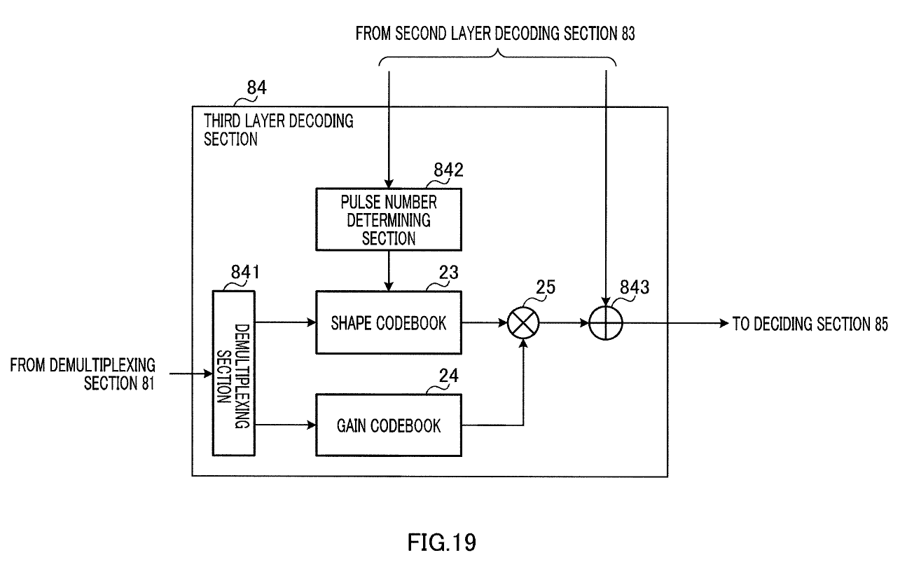

Next, third layer decoding section 84 will be explained in detail. FIG. 19 illustrates the configuration of third layer decoding section 84. Further, in FIG. 19, the same components as in FIG. 5 will be assigned the same reference numerals and their explanations will be omitted.

In third layer decoding section 84 shown in FIG. 19, demultiplexing section 841 demultiplexes the third layer encoded data into the vector candidate index i and gain candidate index m, and outputs the vector candidate index i to shape codebook 23 and the gain candidate index m to gain codebook 24. Further, without demultiplexing section 841, it is possible to demultiplex the third layer encoded data in demultiplexing section 81 and input the resulting indices in third layer decoding section 84.

Pulse number determining section 842 receives the dynamic range information from second layer decoding section 83. As in pulse number determining section 13 shown in FIG. 16, pulse number determining section 842 determines the number of pulses in vector candidates that are outputted from shape codebook 23, based on the dynamic range information, and outputs the determined number of pulses to shape codebook 23.

Adding section 843 generates a third layer decoded spectrum by adding the multiplying result ga(m)·sh(i,k) in multiplying section 25 and the second layer decoded spectrum received from second layer decoding section 83, and outputs the third layer decoded spectrum to deciding section 85.

Thus, according to the present embodiment, there is a layer to perform encoding using dynamic range information among a plurality of layers in scalable coding, so that it is possible to change the number of pulses in vector candidates according to the amount of the dynamic range of an input spectrum, utilizing existing dynamic range information as information to indicate the sharpness of peaks in an input spectrum. Therefore, upon changing the distribution of pulses in vector candidates in scalable coding, the present embodiment needs not calculate a new dynamic range of an input spectrum and needs not newly transmit information to indicate the sharpness of peaks in the input spectrum. Therefore, according to the present embodiment, it is possible to provide the advantage described in Embodiment 1, without an increase of the bit rate in scalable coding.

Further, although an example case has been described with the present embodiment where speech decoding apparatus 80 receives and processes encoded data transmitted from speech encoding apparatus 70, it is equally possible to receive and process encoded data outputted from an encoding apparatus that has other configurations and that can generate the same encoded data as the encoded data outputted as above.

### Embodiment 5

The present embodiment differs from Embodiment 4 in that the positions to allocate pulses in vector candidates are limited to a frequency band in which energy of a decoded spectrum is high in the lower layer.

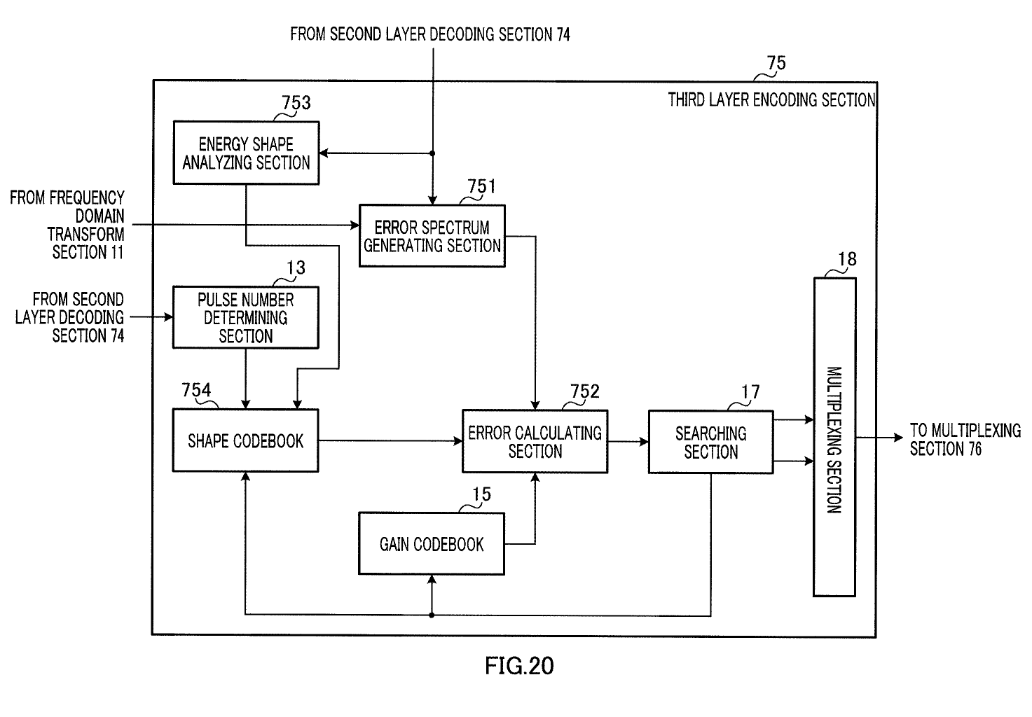

FIG. 20 illustrates the configuration of third layer encoding section 75 according to the present embodiment. Further, in FIG. 20, the same components as in FIG. 16 will be assigned the same reference numerals and their explanations will be omitted.

In third layer encoding section 75 shown in FIG. 20, energy shape analyzing section 753 calculates the shape of energy of the second layer decoded spectrum. To be more specific, energy shape analyzing section 753 calculates the energy shape Ed(k) of the second layer decoded spectrum S3(k) according to equation 13. Further, energy shape analyzing section 753 compares the energy shape Ed(k) and a threshold, and calculates frequency band k in which the energy of the second layer decoded spectrum is equal to or higher than the threshold, and outputs frequency band information to indicate this frequency band k to shape codebook 754.

(Equation 13)

Ed(k)=S3(k)² [13]

There is a high possibility that there are peaks of the input spectrum in the frequency band k in which the energy of the second layer decoded spectrum is equal to or higher than the threshold, and, consequently, the positions to allocate pulses in vector candidates are limited to the frequency band k in shape codebook 754. That is, upon allocating pulses in vector candidates as shown in above FIG. 4, pulses are allocated in the frequency band k in shape codebook 754. Therefore, shape codebook 754 outputs vector candidates in which pulses are allocated in the frequency band k, to error calculating section 752.

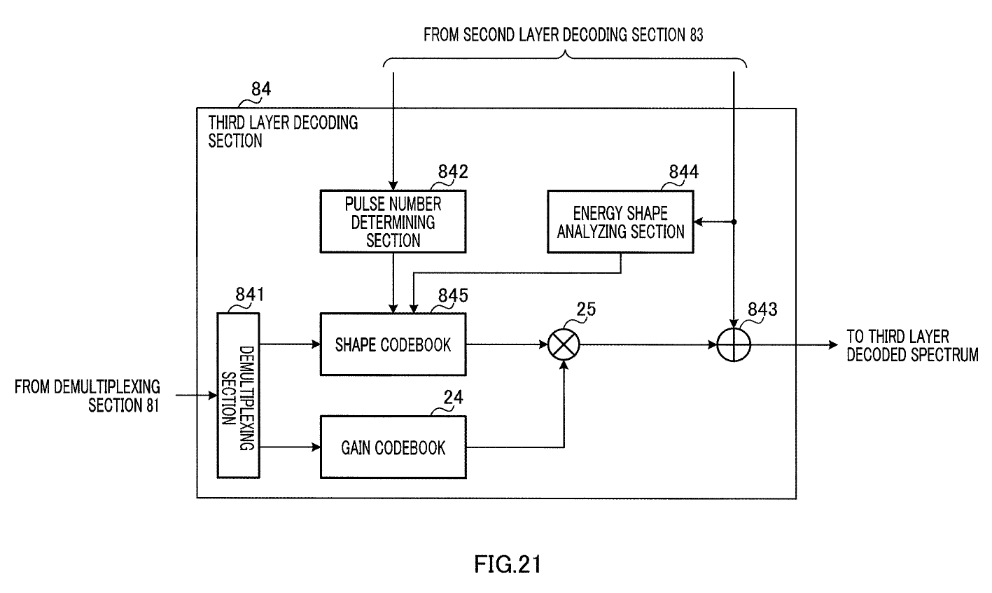

Next, FIG. 21 illustrates the configuration of third layer decoding section 84 according to the present embodiment. Further, in FIG. 21, the same components as in FIG. 19 will be assigned the same reference numerals and their explanations will be omitted.

In third layer decoding section 84 shown in FIG. 21, as in energy shape analyzing section 753, energy shape analyzing section 844 calculates the energy shape Ed(k) of the second layer decoded spectrum, compares the energy shape Ed(k) and a threshold, calculates frequency band k in which the energy of the second layer decoded spectrum is equal to or higher than the threshold, and outputs frequency band information to indicate this frequency band k to shape codebook 845.

Shape codebook 845 limits the positions to allocate pulses according to the frequency band information, and then generates the vector candidate sh(i,k) associated with the index i received from demultiplexing section 841 according to the number of pulses determined in pulse number determining section 842, and outputs the result to multiplying section 25.

Thus, according to the present embodiment, the positions to allocate pulses are limited to a region, in which there is a high possibility of finding peaks in an input spectrum in vector candidates, so that it is possible to maintain the speech quality, reduce allocation information about pulses and reduce the bit rate.

Further, it is possible to include the vicinity of the frequency band k as the positions to allocate pulses in vector candidates.

### Embodiment 6

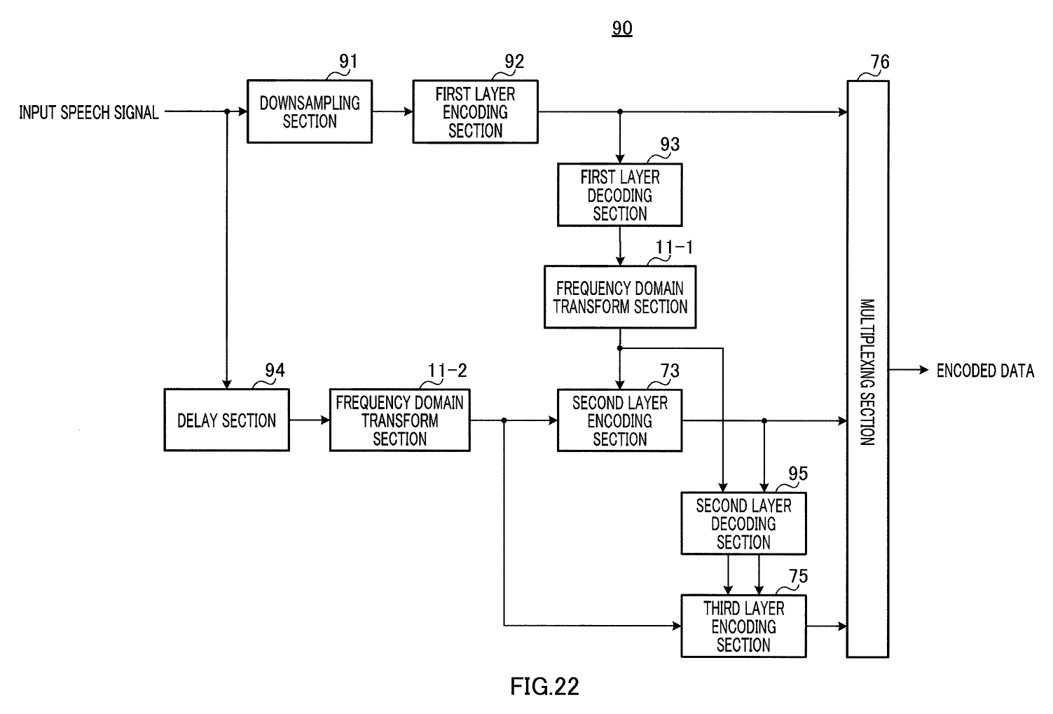

FIG. 22 illustrates the configuration of speech encoding apparatus 90 according to the present embodiment. Further, in FIG. 22, the same components as in FIG. 13 will be assigned the same reference numerals and their explanations will be omitted.

In speech encoding apparatus 90 shown in FIG. 22, downsampling section 91 performs downsampling of an input speech signal in the time domain to transform its sampling rate to a desired sampling rate.

First layer encoding section 92 encodes the time domain signal after the downsampling using CELP (Code Excited Linear Prediction) encoding, to generate first layer encoded data.

First layer decoding section 93 decodes the first layer encoded data to generate a first layer decoded signal.

Frequency domain transform section 11-1 performs a frequency analysis of the first layer decoded signal to generate the first layer decoded spectrum.

Delay section 94 gives to the input speech signal a delay that matches the delay caused in downsampling section 91, first layer encoding section 92 and first layer decoding section 93.

Frequency domain transform section 11-2 performs a frequency analysis of the delayed input speech signal to generate an input spectrum.

Second layer decoding section 95 generates second layer decoded spectrum S3(k) using the first layer decoded spectrum S1 (k) outputted from frequency domain transform section 11-1 and the second layer encoded data outputted from second layer encoding section 73.

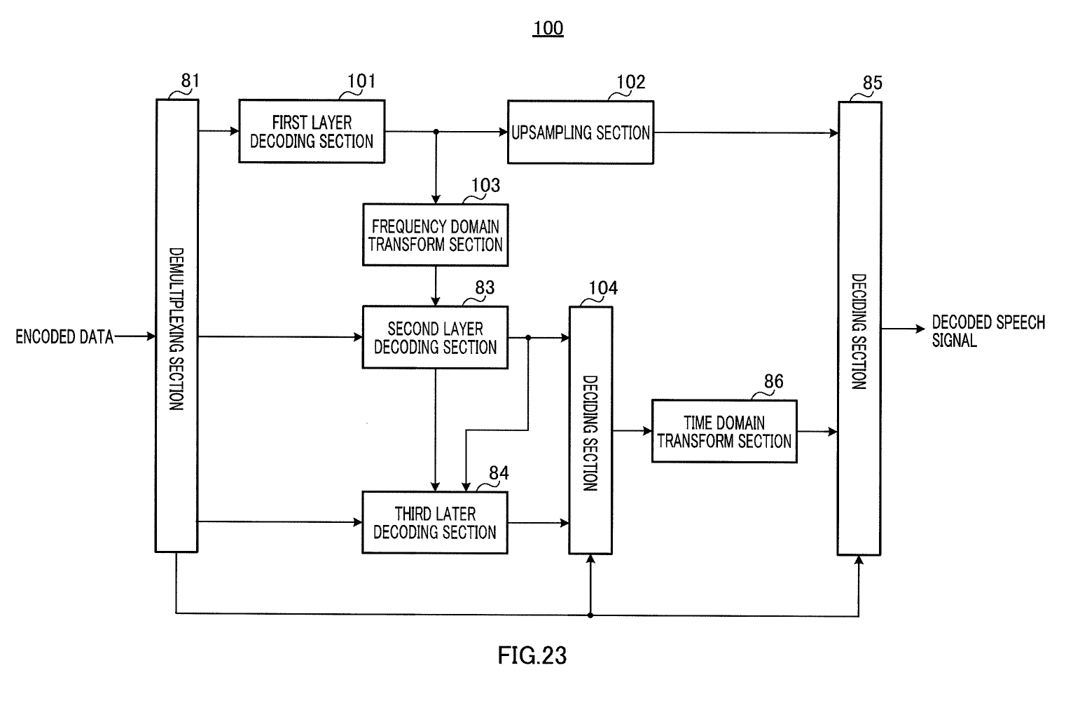

Next, FIG. 23 illustrates the configuration of speech decoding apparatus 100 according to the present embodiment. Further, in FIG. 23, the same components as in FIG. 17 will be assigned the same reference numerals and their explanations will be omitted.

In speech decoding apparatus 100 shown in FIG. 23, first layer decoding section 101 decodes the first layer encoded data outputted from demultiplexing section 81 to acquire the first layer decoded signal.

Upsampling section 102 changes the sampling rate of the first layer decoded signal into the same sampling rate as the input signal.

Frequency domain transform section 103 performs a frequency analysis of the first layer decoded signal to generate the first layer decoded spectrum.

Deciding section 104 outputs one of the second layer decoded signal and the third layer decoded signal, based on the layer information outputted from demultiplexing section 81.

Thus, according to the present embodiment, first layer encoding section 92 performs an encoding process in the time domain. First layer encoding section 92 uses CELP encoding that can encode a speech signal with high quality at a low bit rate. Thus, first layer encoding section 92 uses CELP encoding, so that it is possible to reduce the overall bit rate of the speech encoding apparatus 90 that performs scalable encoding and realize improved sound quality. Further, CELP encoding can alleviate the inherent delay (i.e. algorithm delay) compared to transform encoding, so that it is possible to alleviate the overall inherent delay of the speech encoding apparatus 90 that performs scalable encoding. Therefore, according to the present embodiment, it is possible to realize a speech encoding process and a speech decoding process suitable for mutual communication.

Embodiments of the present invention have been descried above.

Further, the present invention are not limited to the above-described embodiments and can be implemented with various changes. For example, the present invention is applicable to scalable configurations having three or more layers.

Further, as frequency transform, it is possible to use the DFT (Discrete Fourier Transform), FFT (Fast Fourier Transform), DCT (Discrete Cosine Transform), MDCT (Modified Discrete Cosine Transform), filter bank and etc.

Further, an input signal for the encoding apparatus according to the present invention may be an audio signal in addition to a speech signal. Further, it is possible to employ a configuration in which the present invention is applied to an LPC (Linear Prediction Coefficient) prediction residue signal as an input signal.

Further, vector candidate elements are not limited to {−1, 0 and +1}, and the essential requirement is [−a, 0 and +a] (a is an arbitrary value).

Further, the speech encoding apparatus and speech decoding apparatus according to the present invention can be mounted on a communication terminal apparatus and base station apparatus in mobile communication systems, so that it is possible to provide a communication terminal apparatus, base station apparatus and mobile communication systems having the same operational effect as above.

Although a case has been described with the above embodiments as an example where the present invention is implemented with hardware, the present invention can be implemented with software. For example, by describing the speech encoding/decoding method according to the present invention in a programming language, storing this program in a memory and making the information processing section execute this program, it is possible to implement the same function as the speech encoding apparatus of the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-339242, filed on Dec. 15, 2006, including the specification, drawings and abstract, is incorporated herein by reference in its entirety.

### INDUSTRIAL APPLICABILITY

The present invention is applicable to a wireless communication mobile station apparatus and such in a mobile communication system.

1. An encoding apparatus comprising:
a shape codebook that outputs a vector candidate in a frequency domain;
a control section that controls a distribution of pulses in the vector candidate according to sharpness of peaks in a spectrum of an input signal; and
an encoding section that encodes the spectrum using the vector candidate after distribution control.

2. The encoding apparatus according to claim 1, wherein the control section controls the distribution by changing a number of pulses in the vector candidate that is outputted from the shape codebook according to the sharpness of peaks.

3. The encoding apparatus according to claim 2, wherein the shape codebook outputs the vector candidate in which the pulses are allocated in the vicinity of frequencies of integral multiples of a pitch frequency of the input signal.

4. The encoding apparatus according to claim 1, further comprising a dispersing section that disperses the vector candidate using a dispersion vector,
wherein the control section control the distribution by changing a dispersion level in the dispersion vector according to the sharpness of peaks.

5. The encoding apparatus according to claim 1, further comprising a calculating section that calculates a dynamic range of the spectrum as an indicator to indicate the sharpness of peaks,
wherein the control section controls the distribution according to an amount of the dynamic range.

6. The encoding apparatus according to claim 5, further comprising another encoding section that performs encoding in a lower layer than the encoding section,
wherein the another encoding section comprises the calculating section.

7. The encoding apparatus according to claim 1, further comprising a decoding section that generates a decoded spectrum in a lower layer than the encoding section,
wherein the shape codebook outputs the vector candidate allocated the pulses only in a frequency band in which energy of the decoded spectrum is equal to or higher than a threshold.

8. A radio communication mobile station apparatus comprising the encoding apparatus according to claim 1.

9. A radio communication base station apparatus comprising the encoding apparatus according to claim 1.

10. A encoding method comprising:
controlling distribution of pulses in a vector candidate in a frequency domain according to sharpness of peaks in a spectrum of an input signal; and
encoding the spectrum using the vector candidate after distribution control.
